(19) United States
(12) Patent Application Publication
(10) Pub. No.: US 2003/0102336 A1
(43) Pub. Date: Jun. 5, 2003

(54) Watering can

(76) Inventor: Martha Mason, Randolph, NJ (US)

Correspondence Address: Thomas L. Adams, 120 Eagle Rock Avenue, P.O. Box 340, East Hanover, NJ, 07936, US

(21) Appl. No.: 10/346,471

(22) Filed: Jan. 17, 2003

Related U.S. Application Data
(63) Continuation-in-part of application No. 09/972,815, filed on Oct. 9, 2001.

(51) Int. Cl. B67D 3/00

(52) U.S. Cl. 222/478

(57) ABSTRACT

A watering can has a body with a relatively slender spout on one side and on an opposite side a relatively wide spout. The relatively wide spout has a pair of outwardly directed, converging guide surfaces. The body also has an upper handle and a lower handhold. The lower handhold is positioned to permit subjacent grasping.

This is a continuation-in-part of U.S. patent application Ser. No. 09/972,815, filed Oct. 9, 2001.

### BACKGROUND OF THE INVENTION

1. Field of the Invention

The present invention relates to watering cans.

2. Description of Related Art

Conventional watering cans typically have a hollow body with a large hole on top for filling the can. The can typically has a slender spout for dispensing water to a plant. This small spout restricts the flow rate and therefore impedes the watering of a large plant. One may try to dispense large amounts of water by spilling water out of the large filling hole, but such outflow is difficult to control because it results in a fast, broad stream. Some pails and pitchers are fitted with a spout or sluice to control the outflow, but now the gardener must carry two containers: a pitcher, and a conventional watering can. In Design U.S. Pat. No. 279,212 the large fill hole of a watering can is surrounded by a circular wall, but still lacks a spout or sluice as is typically found in a pitcher.

In U.S. Pat. No. 3,648,933 a watering can has long and short spouts on opposite sides. Both spouts have a relatively restricted flow rate. See also U.S. Pat. No. 4,700,892 and Design U.S. Pat. No. 315,755.

In U.S. Pat. No. 4,392,594 a watering can has a pitcher-like spout on one side. On the opposite side a lower opening connects to a hose. The separate can and hose require two hands and will therefore be relatively inconvenient. See also Design U.S. Pat. No. 266,450.

Another difficulty is watering plants that are elevated or suspended from the ceiling. With conventional watering cans, the gardener must hold the can overhead with two hands. However when two hands are employed, the gardener has much less of a reach than would be available if only one hand were used.

Accordingly, there is indeed for an improved watering can that can be conveniently used to dispense water at high or low flow rates, and can also be handled with a single hand, even when pouring water into an elevated plant.

### SUMMARY OF THE INVENTION

In accordance with the illustrative embodiments demonstrating features and advantages of the present invention, there is provided a watering can having body with a water constraining bottom and side. The body has a first spout and opposite thereto a second spout. The first spout has a first opening. The second spout has a second opening that is larger than the first opening. The second spout has a pair of converging guide surfaces that project outwardly to a position out past the side of the body to allow pouring of water without interference from the body.

In accordance with another aspect of the invention a watering can is provided with a body having a spout on one side and on an opposite side an opening. The body has an upper handle and a lower handhold. The lower handhold is positioned to permit subjacent grasping.

By employing structures of the foregoing type, an improved watering can is achieved. In a preferred embodiment a box-like container has a slender spout extending upwardly at approximately a 30° angle of elevation from a lower corner on one side of the container. At an opposite side of the preferred container a wide-mouth sleeve extends upwardly from the top of the container. The vertical annular walls of this sleeve have a teardrop-shaped rim that acts as a spout for pouring a larger volume of water than is feasible from the slender spout.

In this preferred embodiment the lower edge of the container has an opposing pair of recesses that act as a handhold. The gardener can rest the container on the palm of the hand with the thumb in one recess and the four other fingers in the opposite recess. When held in this fashion the arm can then be outstretched and the container can be held overhead in order to water elevated plants.

In this preferred embodiment the slender spout can be fitted with removable attachments such as a sprinkler head or a nozzle. The preferred container can have receptacles to hold attachments that are not in use.

### BRIEF DESCRIPTION OF THE DRAWINGS

The above brief description as well as other objects, features and advantages of the present invention will be more fully appreciated by reference to the following detailed description of presently preferred but nonetheless illustrative embodiments in accordance with the present invention when taken in conjunction with the accompanying drawings, wherein:

FIG. 1 is a perspective view of a watering can in accordance with principles of the present invention;

FIG. 2 is a side view of the watering can of FIG. 1;

FIG. 3 is a bottom view of the watering can of FIG. 1 with a portion of the slender spout broken away for illustrative purposes;

FIG. 4A is a cross-sectional view of the handhold of the watering can of FIG. 1;

FIG. 4B is a cross-sectional view of a handhold that is an alternate to that of FIG. 4A;

FIG. 5 is a detailed, fragmentary view of the slender spout of the watering can of FIG. 1 fitted with a sprinkler head;

FIG. 6 is a detailed, fragmentary view of the slender spout of the watering can of FIG. 1 fitted with a nozzle;

FIG. 7 is a detailed, fragmentary view of the relatively wide spout of the watering can of FIG. 1, but modified to include a bar acting as a splashguard;

FIG. 8 is a detailed, fragmentary view of a relatively wide spout that is an alternate to that of FIG. 7;

FIG. 9 is a detailed, fragmentary view of a relatively wide spout that is an alternate to that of FIG. 7; and

FIG. 10 is a perspective view of a watering can that is an alternate to that of FIG. 1.

### DETAILED DESCRIPTION OF THE PREFERRED EMBODIMENTS

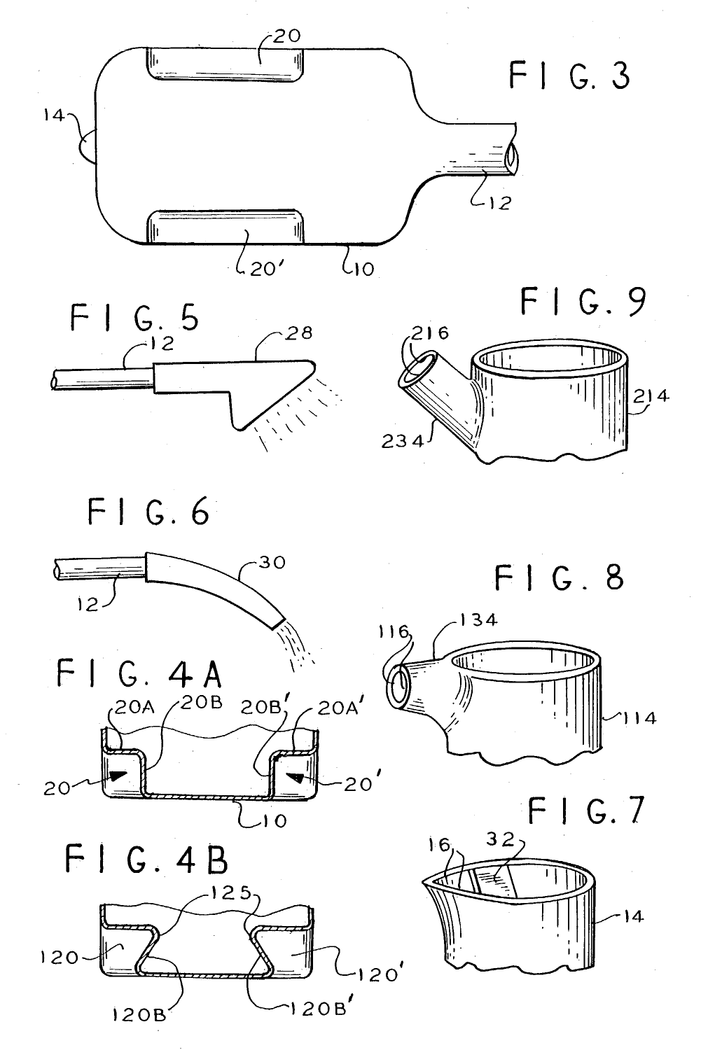

Referring to FIGS. 1, 2, and 3, the illustrated watering can has a box-like molded body 10 in the form of a rectangular prism with rounded corners and with various recesses and spouts. Body 10 has a water constraining bottom B and side S. In this embodiment the side S of the body 10 comprises four flat surfaces. Also, a tapered, slender, first spout 12 is shown projecting near a lower corner of the body 10 at a 30° angle of elevation.

At an opposite upper corner of body 10 a relatively wide, second spout 14 is shown as an upwardly facing opening enclosed by an annular wall having a rim with a pair of outwardly directed, converging guide surfaces 16. Surfaces 16 converge at about 90° into a rounded apex, but other angles of convergence are possible for other embodiments. Also while surfaces 16 are relatively flat, they are still slightly bowed (that is, outwardly convex). In other embodiments, surfaces 16 may be bowed inwardly, that is, outwardly concave. Thus for such embodiments the angle of convergence varies. In still other embodiments, surfaces 16 may be substantially parallel except for their distal ends, which may quickly converge to form there a rectangular or a rounded segment.

In particular, guide surfaces 16 of spout 14 are canted to overhang so that the upper tip T of guide surfaces 16 projects outwardly to give a clearance P out past the side S of body 10. Clearance P is measured as the horizontal displacement of tip T relative to the outermost portion of side S that is below tip T. (Horizontal displacements being observed when bottom B rests on a horizontal surface.) This overhanging of guide surfaces 16 allows one to pour water without interference from body 10.

In this embodiment the top of spouts 12 and 14 are higher than the top surface U and are at approximately the same height. Preferably, the heights of spouts 12 and 14 (specifically, as measured from bottom B to tips T and 12A) differ by less than 20%. Keeping this height difference low allows one to fill the watering can so that water may be contained even in the spouts 12 and 14 without spilling.

An upper handle 18 is shown as a tubular arch spanning between (1) an outside portion of spout 14 opposite surfaces 16, and (2) an upper portion of spout 12 that is slightly less than halfway up the length of the spout. It will be appreciated that in other embodiments either end of handle 18 may attach directly to body 10.

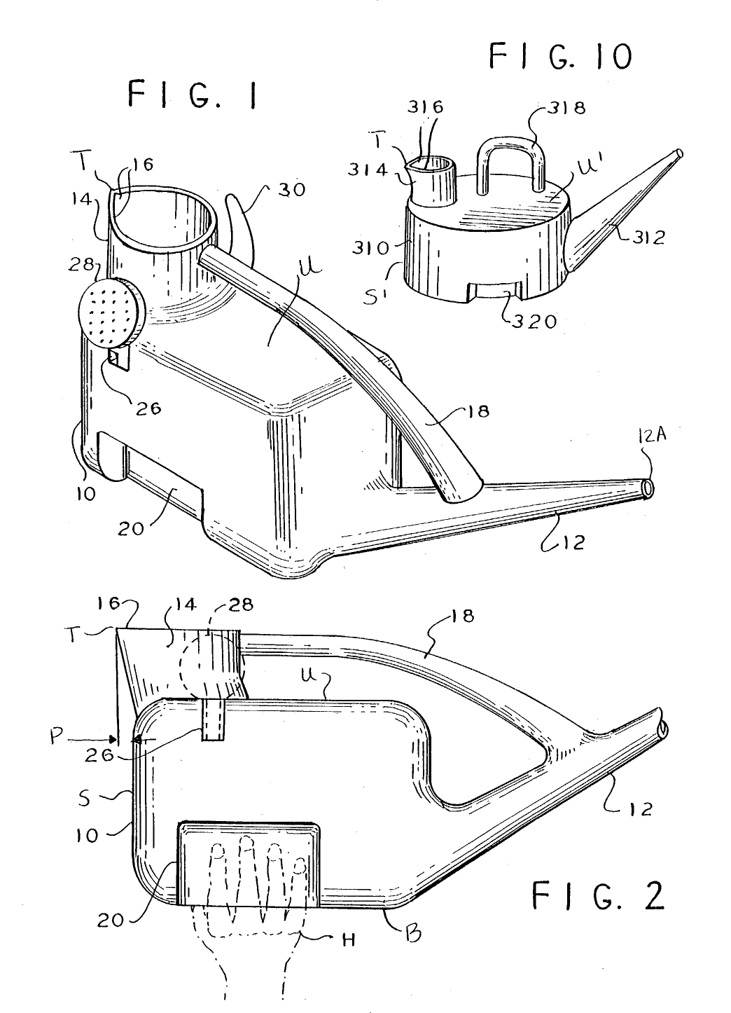

A lower handhold is shown herein as a pair of alcoves 20 and 20′ located at parallel lower edges of body 10. Each of the alcoves 20 and 20′ are dimensioned to receive one or more phalanges from four fingers of hand H (FIG. 2). When one of the alcoves receives four fingers, the opposite alcove receives a thumb so that the palm of hand H subjacently supports the bottom of body 10. As shown in FIG. 4A, alcoves 20 and 20′ have substantially horizontal ceilings 20A and 20A′ and vertical interior walls 20B and 20B′. In other embodiments however, interior walls 120B and 120B′ may be canted as shown in FIG. 4B to form finger niches 125.

Referring again to FIGS. 1, 2, and 3, a recess 26 formed at an upper corner of body 10 alongside spout 14 acts as a receptacle for receiving a removable attachment, specifically sprinkler head 28 (or nozzle 30). It will be appreciated that nozzle 30 is held in a complementary recess (not shown) on the opposite side of body 10. Recess 26 may tightly receive attachments 28 and 30 or may have a restricted opening so that the attachments snap into place. Alternatively, the recess 26 may have on its floor an upwardly projecting stud onto which the attachment snugly fits.

As shown in FIG. 5 sprinkler head 28 may fit over the distal end of slender nozzle 12 to produce a diffuse spray. As shown in FIG. 6, nozzle 30 can replace sprinkler head 28 to provide a relatively narrow stream that would be useful for watering small plants.

Referring to FIG. 7, previously illustrated spout 14 is shown modified with a bar 32 acting as a splashguard. Bar 32 restricts the flow rate and prevents a surge of water from splashing out of the spout past surfaces 16.

Referring to FIG. 8, alternate spout 114 has a conduit 134 formed in the side of spout 114. Accordingly, water can flow through spout 114 into conduit 134, guided by the converging surfaces 116. Referring to FIG. 9, another spout 214 has an alternate conduit 234, which is substantially cylindrical. Accordingly, water can flow through spout 214 into conduit 234 guided by the converging surfaces 216 (the convergence abruptly occurs at the junction between spout 214 and conduit 234). As before, spout 134 provides the overhanging feature previously mentioned in connection with the embodiment of FIGS. 1-3 (clearance P). Also, spout 234 provides a similar overhanging feature.

Referring to FIG. 10, components corresponding to those illustrated in FIG. 1 have the same reference numeral but increased by 300. Specifically, body 310 is a cylindrical container having on top an inverted U-shaped handle 318. A slender spout 312 upwardly projects from one side of cylindrical body 310 while the other side has a relatively wide spout 314 with a pair of converging surfaces 316 for dispensing water at a relatively high volume. A pair of handhold alcoves 320 are positioned along the lower edge of cylindrical body 310 at diametrically opposite positions. As before, tip T′ overhangs to provide a horizontal clearance out past side S′ to allow one to pour water without interference.

To facilitate an understanding of the principles associated with the foregoing apparatus, its operation will be briefly described in connection with the embodiment of FIG. 1. The gardener may fill body 10 with water through the opening of spout 14. The watering can may then be carried with handle 18. For larger plants, the gardener will tilt body 10 so that water flows through the relatively large opening of spout 14. Converging surfaces 16 accurately guide and converge the water flow.

For small plants the gardener may tilt body 10 in the opposite direction to dispense water through the relatively slender spout 12, which produces a relatively slow flow rate. For especially small plants, nozzle 30 can be removed from its receptacle and placed on the distal end of spout 12 as shown in FIG. 6. Thereafter, the nozzle 30 can be replaced in a receptacle and sprinkler head 28 may be installed as shown in FIG. 5 to produce a more diffused flow. It will be appreciated that items 28 and 30 can be stored in either one of the receptacles 26.

Some plants may be elevated, for example, by being suspended from a ceiling or other structure. In such cases, the gardener may grip the underside of the watering can as shown in FIG. 2. While a right hand is shown in FIG. 2, a left hand can be used since the alcoves 20 and 20′ are identical. Furthermore, whether a right or left hand is used, a thumb (or four fingers) can be placed in either one of the alcoves 20 or 20′. Once this handhold is seized, the gardener may reach up, allowing the body 10 to rest on the palm of hand H. Thereafter, body 10 can be tilted as before to dispense water through either spout 12 or 14.

It is appreciated that various modifications may be implemented with respect to the above described, preferred embodiment. In particular, the watering can may be made of a variety of molded plastics formed from one or more components that may be glued or snapped together. In other embodiments stamped sheet metal or other materials may be used instead. Alternate embodiments may offer a watering can that is relatively larger or smaller. For some larger watering cans the handhold may be formed from alcoves on the bottom of the container body that do not reach the sides of the container body, especially if the average hand would not be able to stretch to the opposite edges of the body. Also, the alcoves can be made wider so that a hand can be shifted to change the balance point, depending upon which spout is to be used. Furthermore, the alcoves need not have flat surfaces, but these surfaces may be rounded or may be sculpted to provide a number of finger grooves.

Obviously, many modifications and variations of the present invention are possible in light of the above teachings. It is therefore to be understood that within the scope of the appended claims, the invention may be practiced otherwise than as specifically described.

1. A watering can comprising:
a body with a water constraining bottom and side, said body having a first spout and opposite thereto a second spout, said first spout having a first opening, said second spout having a second opening that is larger than said first opening, said second spout having a pair of converging guide surfaces that project outwardly to a position out past the side of said body to allow pouring of water without interference from said body.

2. A watering can according to claim 1 wherein said body has a top surface and wherein said first spout and said second spout rise higher than said top surface by at least a predetermined amount.

3. A watering can according to claim 2 wherein said first spout and said second spout rise to heights that differ by less than 20%, relative to the bottom of said body.

4. A watering can according to claim 1 wherein said second opening faces upwardly.

5. A watering can according to claim 3 wherein said second spout comprises an annular wall extending upwardly from said body.

6. A watering can according to claim 1 wherein said second spout comprises an annular wall extending upwardly from said body.

7. A watering can according to claim 6 wherein annular wall is spanned by a bar acting as a splashguard.

8. A watering can according to claim 3 wherein said annular wall has (a) a conduit projecting laterally therefrom, and (b) an upwardly facing third opening.

9. A watering can according to claim 1 comprising:
at least one removable attachment attached to said first spout.

10. A watering can according to claim 6 wherein said body has a holder for holding said removable attachment, so that said removable attachment can be removed from said first spout and stored at said holder.

11. A watering can according to claim 7 wherein said at least one removable attachment comprises a pair of removable attachments, one stored at said holder and one mounted on said first spout.

12. A watering can according to claim 1 wherein said pair of removable attachments comprise a sprinkler head and a nozzle.

13. A watering can according to claim 1 wherein said body comprises:
an upper handle spanning said first and said second spouts.

14. A watering can according to claim 1 wherein said body comprises:
an upper handle and a lower handhold, said lower handhold being positioned to permit subjacent grasping.

15. A watering can according to claim 14 wherein said lower handhold comprises an opposite pair of alcoves formed in said body.

16. A watering can according to claim 15 wherein said body has a bottom and wherein said opposite pair of alcoves are located at the bottom of said body.

17. A watering can according to claim 15 wherein each of said alcoves are four finger widths wide.

18. A watering can according to claim 15 wherein each of said alcoves are sized to receive at least one phalange of each of four fingers.

19. A watering can according to claim 15 wherein each of said alcoves has a finger niche above a rounded ridge, so that fingers can wrap around said ridge and fit into said finger niche.

20. A watering can comprising:
a body having a bottom with a border, a spout on one side and on an opposite side an opening, said body having an upper handle and a lower handhold, said lower handhold being positioned to give the border of the bottom a concave portion permitting subjacent grasping with a palm against the underside.

21. A watering can according to claim 20 wherein said lower handhold comprises an opposite pair of alcoves formed in said body.

22. A watering can according to claim 19 wherein said opposite pair of alcoves are located at the bottom of said body.

23. A watering can according to claim 21 wherein each of said alcoves are four finger widths wide.

24. A watering can according to claim 21 wherein each of said alcoves are sized to receive at least one phalange of each of four fingers.

25. A watering can according to claim 21 wherein each of said alcoves has a finger niche above a rounded ridge, so that fingers can wrap around said ridge and fit into said finger niche.
